(19) United States
(12) Patent Application Publication
(10) Pub. No.: US 2007/0022782 A1
(43) Pub. Date: Feb. 1, 2007

(54) Method for producing polarizing glass

(75) Inventors: Yuichi Aoki, Niigata (JP); Masahiro Ichimura, Tokyo (JP)

Correspondence Address: OSHA LIANG L.L.P., 1221 MCKINNEY STREET, SUITE 2800, HOUSTON, TX, 77010, US

(73) Assignee: Arisawa Mfg. Co., Ltd., Niigata (JP)

(21) Appl. No.: 11/193,036

(22) Filed: Jul. 29, 2005

(51) Int. Cl. C03C 10/16; C03B 23/00

(52) U.S. Cl. 65/33.3; 65/102

(57) ABSTRACT

There is provided a manufacturing method of polarizing glass through which residual strain within a heated and elongated glass sheet is steadily removed. The manufacturing method of polarizing glass includes steps of precipitating metal halide dispersed within glass into a predetermined particle size to form glass preform after melting the glass containing the metal halide, elongating the glass preform after heating up to predetermined temperature to form a glass sheet containing metal halide particles, annealing the glass sheet by heating up to temperature below transition temperature and above straining temperature of the glass, polishing the glass sheet annealed through the annealing step and reducing the metal halide particles within the glass sheet polished through the polishing step.

### FIELD OF THE INVENTION

The present invention relates to a manufacturing method of polarizing glass and more specifically to a manufacturing method of polarizing glass having an elongation step of elongating metal halide particles contained in glass preform to obtain a glass sheet.

### BACKGROUND ART

Polarizing glass is used in a polarization dependent optical isolator in a near-infrared region for use in optical communications. The optical isolator has two polarizing glass sheets and a magnetic garnet film interposed between them. The optical isolator transmits light entering from a laser diode (LD), i.e., a light source, and cuts off light returning to the LD.

The polarizing glass used in the optical isolator is manufactured through steps of melting base glass containing halide, precipitating (or heat-treating) metal halide particles within the mother glass, elongating the glass containing the metal halide particles, polishing the elongated glass and reducing the metal halide particles within the glass.

Within these steps, stress is applied to glass preform to elongate the metal halide particles contained in the glass preform to form a glass sheet in the elongation step. In this step, the glass preform is elongated when viscosity of the glass is about 1×10¹⁰ poise with the stress of 200 Kg/cm² to 700 Kg/cm² in order to obtain a predetermined aspect ratio by elongating the metal halide particle. However, there has been a problem in this case that residual strain is produced within the glass sheet after the elongation and therefore the glass sheet is apt to be damaged or destroyed during the step of finishing and polishing thereafter.

As a method for preventing the damage or destruction of the glass sheet after the elongation, there has been proposed a method of relaxing the residual strain produced within the glass sheet during the elongation step by implementing an annealing process to the heated and elongated glass sheet e.g. disclosed in Japanese Patent Laid-Open No. 2005-47734. The document clearly specifies a condition that temperature for implementing the annealing process to the heated and elongated glass sheet should be below melting point of the metal halide contained in the glass sheet.

It is known that strain of glass may be removed by slowly lowering temperature from predetermined temperature to the straining temperature between annealing point temperature and straining temperature. Here, the annealing point temperature of the polarizing glass is higher than the melting point of metal halide and the straining temperature thereof is about the same as the melting point of metal halide.

Accordingly, because the straining temperature and the melting point of metal halide is very close, a temperature width of the annealing process as proposed in the document is very narrow. Or, the melting point of metal halide is lower than the straining temperature of glass depending on glass and composition of metal halide to be blended, so that the temperature range of the annealing process as proposed in the above-mentioned document does not exist in this case.

### SUMMARY OF INVENTION

In order to solve the above-mentioned problem, according to a first aspect of the invention, a manufacturing method of polarizing glass includes steps of precipitating metal halide precipitated within glass into a predetermined particle size to form glass preform after melting the glass containing the metal halide, elongating the glass preform after heating to predetermined temperature to form a glass sheet containing metal halide particles, annealing the glass sheet by heating up to temperature below transition temperature and above straining temperature of the glass, polishing the glass sheet annealed through the annealing step and reducing the metal halide particles within the glass sheet polished through the polishing step. Thereby, the temperature range of the annealing step for removing the residual strain caused within the glass sheet through the elongation step may be widened. Therefore, the temperature of the annealing step may be easily controlled, allowing to remove the residual strain within the glass sheet more steadily.

In the first aspect, the temperature of the glass sheet in the reducing step may be lower than the temperature of the glass sheet heated in the annealing step. The annealing temperature is set to be lower than lower limit temperature by which the metal halide particle is re-globulized. However, because the boundary between the re-globulizing temperature and non-re-globulizing temperature is not clear, there is a possibility that the glass sheet is placed in the re-globulizing temperature range even na short time, thus lessening the aspect ratio by a small margin in some cases due to unexpected fluctuation of the annealing temperature, to width of thermal characteristic temperature of the glass sheet (normally, the thermal characteristic value has a temperature range of several degrees or more) and the like. Although such level of fluctuation will normally bring about no serious adverse effect to the extinction ratio characteristics, the aspect ratio is lessened further if the processing temperature in the reducing step, i.e., the post processing, is equal to or higher than the annealing temperature, and possibly no extinction ratio may be obtained in predetermined wavelength in the end. Therefore, no re-globulizing occurs at all if the reducing temperature is set to be lower than the annealing temperature because it is certainly lower than the lower limit of the re-globulizing temperature. Accordingly, the yields will not drop in the reducing step.

Still more, the temperature of the glass sheet in the reducing step may be higher than the melting point of the metal halide. It enables a time required for the reducing step to be shortened. Still more, because the metal halide particles within the glass sheet melt and flow within the particles, more metal halide contacts with the reducing atmosphere and is reduced.

In this case, the glass sheet may be rocked. It enables the fluid metal halide particles within the glass sheet to be reduced effectively in a short time.

Still more, the predetermined particle size may be 60 nm or less in the precipitating step. Thereby, the metal halide particles will not be globulized again even if they undergo the elongation step, the annealing step, the polishing step and the reducing step and as a result, it becomes possible to provide polarizing glass which has favorable optical characteristics.

Still more, the glass preform may be heated up to the temperature for which viscosity thereof becomes 1×10⁸ poise to 1×10¹⁴ poise and may be pulled by tensile force of 100 Kg/cm² to 700 Kg/cm² in the elongation step. It enables the aspect ratio of the elongated metal halide particles to be controlled and the required optical characteristics to be fulfilled in the polarizing glass.

As it is apparent from the above description, the temperature range of the annealing step for removing the residual strain caused within the glass sheet through the elongation step may be widened in manufacturing the polarizing glass. It then enables one to easily control the temperature of the annealing step and to remove the residual strain within the glass sheet more steadily.

It is noted that the summary of the invention described above does not necessarily describe all the necessary features of the invention. The invention may also be a sub-combination of the features described above.

### BRIEF DESCRIPTION OF THE DRAWINGS

FIG. 1 shows a structure of a elongating device used in a elongation step of a preferred embodiment.

FIG. 2 shows a structure of tensile means in the elongating device.

FIG. 3 is a conceptual drawing showing a state in which metal halide particles are elongated.

FIG. 4 shows a structure of a rocking device for rocking glass sheets.

### DETAILED DESCRIPTION OF THE INVENTION

The invention will now be described based on a preferred embodiment while showing operations of the invention based on the drawings, which do not intend to limit the scope of the invention, but exemplify the invention. All of the features and the combinations thereof described in the embodiment are not necessarily essential to the invention.

A manufacturing method of polarizing glass of the present embodiment includes steps of melting base glass containing halide, precipitating metal halide particles within the base glass, elongating the glass containing the metal halide particles, annealing the elongated glass, polishing the annealed glass and reducing the metal halide particles within the polished glass,

Glass in which metal halides, e.g., AgCl and AgBr, are dispersed is used as the base material in the present embodiment. Table 1 shows compositions of the base glasses of the present embodiment.

TABLE 1

| Composition | #1 (wt %) | #2 (wt %) | #3 (wt %) |
|---|---|---|---|
| R₂O | 13 | 11.6 | 13 |
| Li₂O | 1.8 | 1.8 | 1.8 |
| Na₂O | 5.5 | 4.1 | 5.5 |
| K₂O | 5.7 | 5.7 | 5.7 |
| B₂O₃ | 18.2 | 18.1 | 18.2 |
| Al₂O₃ | 6.2 | 6.2 | 6.2 |
| SiO₂ | 56.3 | 56.3 | 56.3 |
| CuO | 0.01 | 0.006 | 0.01 |
| Ag | 0.24 | 0.22 | 0.22 |
| Cl | 0.16 | 0.24 | 0.14 |
| Br | 0.16 | 0.20 | 0.14 |
| ZrO₂ | 5.0 | 5.0 | 5.0 |
| TiO₂ | 2.3 | 2.3 | 2.3 |
| F | — | — | 0.5 |

In the precipitating step, glass preform is formed by precipitating the metal halide dispersed within the glass into a predetermined particle size after melting the glass containing the metal halide. More specifically, after melting the glass in which the metal halide is dispersed, the glass preform is cut out of the melted glass after forming into a sheet or a block. Then, the glass preform is heated to precipitate metal halide particles. The precipitated metal halide particles are considered to be mixed crystals of AgCl, AgBr or AgClBr. Here, the melting point of AgCl is 449° C. and that of AgBr is 434° C. Table 2 shows thermal characteristics of the material glasses of the embodiment. It is noted that an error of the temperature is around ±10° C.

TABLE 2

| | Straining | | Annealing | Softening |
|---|---|---|---|---|
| Composition of | Point Temp. | Transition | Point Temp. | Point Temp. |
| Glass | (° C.) | Temp. (° C.) | (° C.) | (° C.) |
| #1 | 440 | 515 | 540 | 700-730 |
| #2 | 435 | 505 | 530 | 700-730 |
| #3 | 430 | 500 | 520 | Below 700 |

An aspect ratio of the metal particle is a ratio of length and breadth of the metal particle reduced in the reducing step after being elongated in the elongation step. The characteristics of the polarizing glass or an extinction ratio in particular is affected by this aspect ratio. Here, the larger the size of the metal halide particle is in the precipitating step, the more easily the metal halide particle is re-globulized when it is melted after elongation due to surface tension and the smaller the aspect ratio becomes. Accordingly, it is preferable to lessen the particle size so that the metal halide particles will not be globulized again in the annealing and reducing steps. Then, the particle size of the metal halide particle to be precipitated is preferred to be 60 nm or less in the precipitating step of the embodiment. Thereby, the elongated metal halide particles are hardly re-globulized even if the glass sheet after elongation is heated up to temperature higher than the melting point of the metal halide in the annealing and reducing steps.

Next, the glass preform is heated to predetermined temperature and is elongated to form the glass sheet having the elongated metal halide.

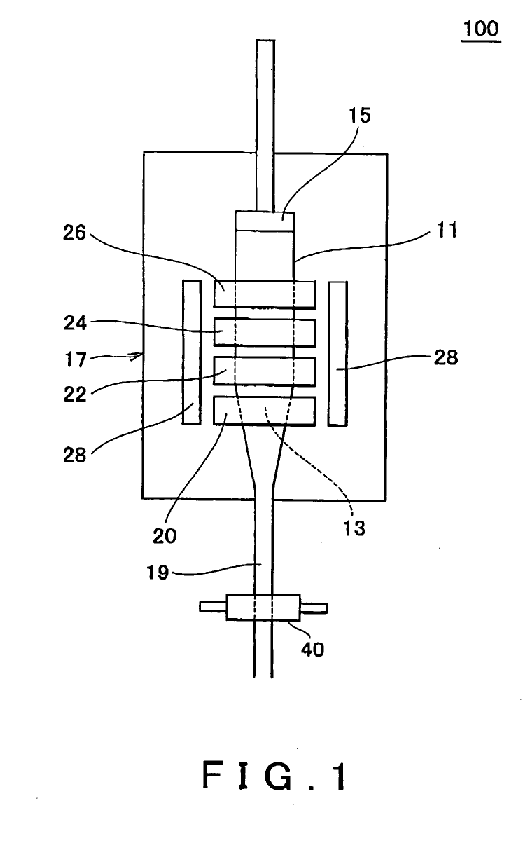

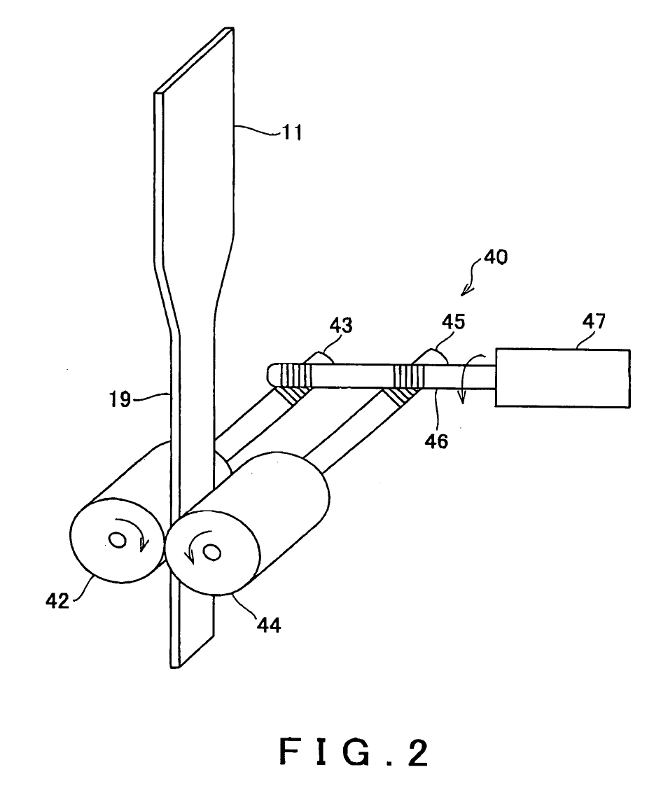

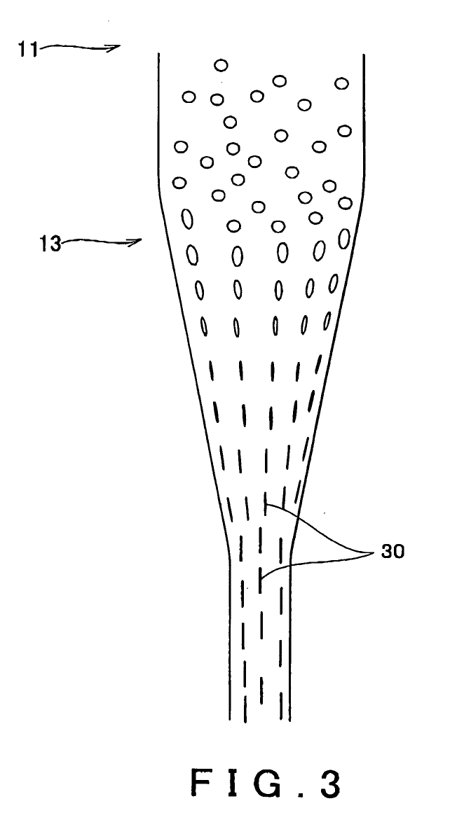

FIG. 1 shows a structure of a elongating device 100 used in the elongation step of the embodiment. FIG. 2 shows a structure of tensile means 40 in the elongating device 100. FIG. 3 is a conceptual drawing showing a state in which metal halide particles 30 within glass preform 11 are elongated when the glass preform 11 is elongated in the elongation step.

In the embodiment shown in FIG. 1, the elongating device 100 has an electric furnace 17, a glass supporter 15 provided within the electric furnace 17, a main heater 20 provided also within the electric furnace 17, sub-heaters 22, 24 and 26, a side heater 28 and the tensile means 40 provided under the various heaters described above in terms of the longitudinal direction of the glass preform 11.

The elongating device 100 elongates the glass preform 11 in which the metal halide is precipitated into a predetermined particle size through the precipitating step while heating by the main heater 20, the sub-heaters 22, 24 and 26 and the side heater 28 provided within in the electric furnace 17. Thereby, the metal halide particles 30 contained within the glass preform 11 are elongated and the glass sheet 19 containing the elongated metal halide particles 30 is formed. Concretely, the elongating device 100 fixes the glass preform 11 by the glass supporter 15 and pulls by the tensile means 40 in the longitudinal direction while heating by the various heaters disposed around the glass preform 11. According to the embodiment, one end of the glass preform 11 is pulled downward by the tensile means 40 provided under the heaters while slowly moving down the glass supporter 15 for fixing the other end of the glass preform 11 formed into a shape of strip in the longitudinal direction. The present embodiment will now be explained by using the positional relationship in FIG. 1. However, the direction for elongating the glass preform 11 is not limited to be the downward direction. For instance, an upper side of the glass preform 11 may be pulled upward by the tensile means 40 provided above the heaters by fixing the lower end of the glass preform 11 by the glass supporter 15.

The glass preform 11 is heated by the main heater 20 for heating around the center of the elongation section 13 in the width direction from the front side of the strip in the elongation section 13 where contraction of the glass preform 11 in the width direction occurs, the side heaters 28 for heating the sides of the elongation section 13 from the sides of the strip in the elongation section 13 and the sub-heaters 22, 24 and 26 disposed at predetermined intervals above the main heater 20.

The width of the main heater 20 and the sub-heaters 22, 24 and 26 is slightly wider than that of the glass preform 11. Outputs of the main heater 20, the sub-heaters 22, 24 and 26 and the side heater 28 are controlled independently. Thereby, the glass preform 11 is heated with temperature distribution suited for the elongation. That is, the glass preform 11 is heated with the temperature distribution by which the glass preform 11 is elongated favorably and the metal halide particles 30 are elongated favorably as the glass preform 11 is elongated. The sub-heaters 22, 24 and 26 heat the upper part of the elongation section 13 step by step.

In the embodiment shown in FIG. 2, the tensile means 40 has a pair of rollers 42 and 44 that pinch the front and back faces of the glass sheet 19, plungers 43 and 45 that rotate in a body with the pair of rollers 42 and 44, respectively, a driving shaft 46 for rotating those plungers 43 and 45 mechanically in synchronism and a motor 47 for supplying rotational driving force to the driving shaft 46. According to the present embodiment, twisted gears having an equal pitch are formed on the plungers 43 and 45 and a gear engaging with those twisted gears is formed on the driving shaft 46.

In the present embodiment, it is preferable to heat the glass preform 11 up to temperature effecting from 1×10⁶ poise to 1×10¹⁴ poise of viscosity and to pull it with tensile stress of 100 Kg/cm² to 700 Kg/cm² in elongation.

After the elongation step described above, the glass sheet 19 is heated up to temperature below the transition temperature and above the straining temperature of the glass and is then cooled in the annealing step. Here, the annealing step includes heating and cooling operations, which is called “Yakinamashi” in Japanese, for relaxing residual stress (or residual strain) caused within the internal structure of an individual material due to heat treatment and machining process. In the present embodiment, the annealing step includes the heating and cooling operations for removing the residual strain within the glass sheet 19 formed through the elongation step.

In the annealing step of the embodiment, the thermal characteristics and melting point of the metal halide shown in Table 1 is close to the straining temperature of glass. Accordingly, the metal halide particles 30 elongated in the glass sheet 19 are considered to be melting in the temperature range below the transition temperature and above the straining temperature of the glass. However, the glass sheet 19 itself keeps a rigid state and the metal halide particles 30 are held in the elongated shape by the surrounding glass phase even if it is melted.

If the glass sheet 19 is heated up to temperature above the transition temperature, the glass is put into a viscoelastic state, the metal halide particles 30 elongated within the glass sheet 19 are re-globulized and their aspect ratio drops. Accordingly, it becomes difficult to obtain desirable optical characteristics as polarizing glass as the extinction ratio drops for example. Meanwhile, the residual strain within the glass sheet 19 is hardly removed if the glass sheet 19 is heated up only to temperature below the straining temperature.

Then, according to the present embodiment, after heating the glass sheet 19 to 480° C. which is below the transition temperature and above the straining temperature of the glass within an annealing furnace, it is held for 2.2 hours and is cooled naturally within the furnace after lowering slowly the temperature to 400° C. which is lower than the straining temperature with a pace of 1° C./minute or less.

After the annealing step, the annealed glass sheet 19 is polished in the polishing step. One side of the glass sheet 19 is polished at a time in the polishing step of the present embodiment. Concretely, the glass sheet 19 is pasted to a polishing table by means of wax and one side thereof is polished at first. After ending polishing of one side, the polishing table is heated to soften the wax, the other side opposite from the polished side is exposed and is fixed again by the wax so that the exposed side is polished, A load of a degree that will not break the glass sheet 19 is applied during polishing.

Thickness of the glass sheet 19 undergoing the polishing step is preferable to be close to target thickness after polishing because polishing time may be shortened. However, the glass sheet 19 has subtle warp and curve. Then, according to the present embodiment, the glass sheet 19 undergoing the polishing step is formed so that its thickness is thicker than the target thickness by 200 μm (to be thicker by 100 μm per one side). It facilitates surfacing in the polishing step.

Although the method of polishing one side of the glass sheet 19 at a time has been used in the polishing step described above, there is also a method of polishing the both sides of the glass sheet 19 in the same time and the most suitable method may be adequately selected depending on the condition of the glass sheet 19 to be polished and on a target shape.

After the polishing step described above, the metal halide particles 30 within the glass sheet 19 are reduced in the reducing step. More specifically, polarizing characteristic is given to the glass sheet 19 from which the residual strain is removed through the annealing step by reducing at least part of the metal halide particles 30 elongated within the glass sheet 19 into elongated metal particles.

The temperature of the glass sheet 19 in the reducing step may be lower than that of the glass sheet 19 heated in the annealing step. Still more, the temperature of the glass sheet 19 may be higher than the melting point of metal halide. Here, the temperature of the glass sheet 19 heated in the annealing step is 480° C. in the present embodiment.

The reducing step of the present embodiment is carried out by placing the glass sheet 19 within a chamber of hydrogen atmosphere and by heating for one to five hours at about 470° C.

Although the temperature within the furnace is lower than the transition temperature of glass, it is higher than the melting point of the metal halide particles 30. Accordingly, although the metal halide particles 30 within the glass sheet 19 melt in the reducing step, they are considered to be held in the elongated shape by the surrounding glass phase similarly to the case in the annealing step. Still more, because the metal halide particles 30 flow within the shapes formed by the surrounding glass phase, the more metal halide particles contact with the reducing atmosphere and are reduced as compared to a case of reducing the metal halide particles 30 at temperature lower than the melting point of the metal halide particles 30, i.e., when the metal halide particles 30 within in the glass sheet 19 are reduced in a solid state. Still more, as compared to the case of reducing the metal halide particles 30 at the temperature lower than the melting point of thereof, the reducing reaction takes place quickly, so that a time required for the reducing step may be shortened.

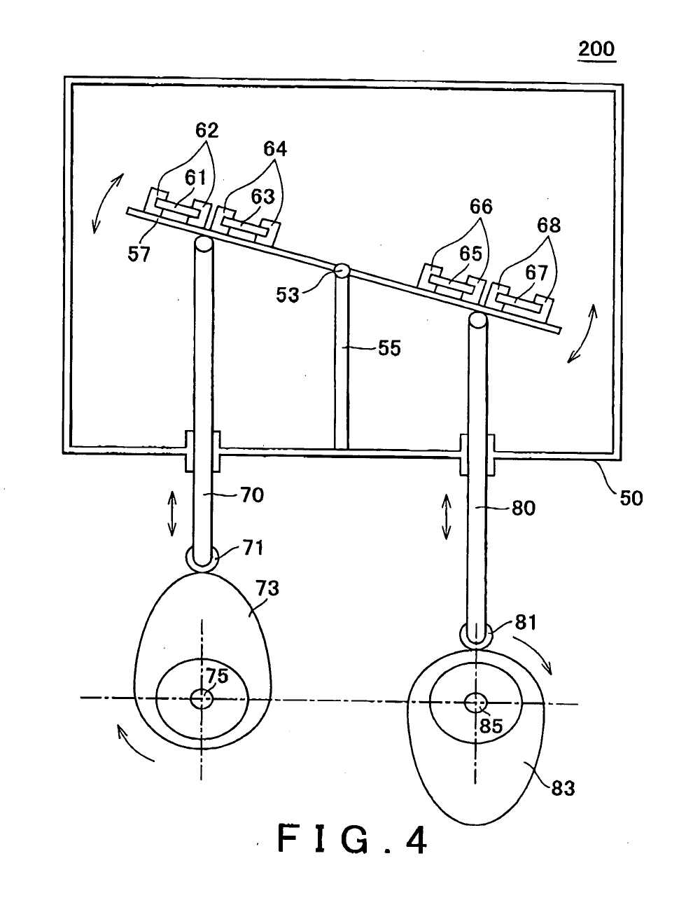

The glass sheet 19 may be also rocked in the reducing step. FIG. 4 shows a structure of a rocking device 200 for rocking glass sheets 61, 63, 65 and 67 within a chamber 50 kept in a reducing atmosphere in the reducing step of the present embodiment.

The rocking device 200 has a table 57 for supporting the glass sheets 61, 63, 65 and 67, a supporting rod 55 fixed at one face within the chamber 50 and having a hinge 53 at the end on the opposite side to the fixed side, left and right plungers 70 and 80 for supporting the both ends of the table 57, left and right cam followers 71 and 81 disposed respectively at the edges of the left and right plungers 70 and 80 on the opposite side from the side supporting the table 57 and left and right cams 73 and 83 contacting respectively with the left and right cam followers 71 and 81.

The supporting rod 55 supports the table 57 through an intermediary of the hinge 53. The table 57 is allowed to turn centering on the hinge 53 and reducing jigs 62, 64, 66 and 68 are fixed to the table 57 by screws or the like. Each of the reducing jigs 62, 64, 66 and 68 has a pair of U-shaped fixtures facing to each other and each of the glass sheets 61, 63, 65 and 67 is inserted into and supported by a groove formed by the U-shaped fixtures facing to each other.

The left and right cams 73 and 83 are rotatably held in a body with left and right master shafts 75 and 85. Thereby, the left and right cams 73 and 83 rotate respectively in synchronism with the rotation of the left and right main shafts 75 and 85. Here, the left and right main shafts 75 and 85 are disposed in parallel, the left and right cams 73 and 83 have the same shape and lobes of the respective cams are disposed at a position 180 degrees opposite to each other with respect to an axis of the master shafts. For instance, when the lobe of the left cam 73 faces right up (when it contacts with the left cam follower 71), the lobe of the right cam 83 faces right down.

When the rotation speed and direction of the left and right main shafts 75 and 85 are the same and as the left cam 73 rotates from the state in which the lobe contacts with the left cam follower 71, the left plunger 70 moves down vertically. In the same manner, the right plunger 80 moves up vertically as the right cam 83 rotates. The table 57 supported by the left and right plungers 70 and 80 rocks centering on the hinge 53 from the position tilted left up (position in FIG. 4) to the position right up due to the vertical movement of the left and right plungers 70 and 80.

The metal halide particles 30 having the fluidity and contained in the glass sheets 61, 63, 65 and 67 retained in the reducing jigs 62, 64, 66 and 68 and placed on the surface of the table 57 on the opposite side where it is supported by the left and right plungers 70 and 80 may be effectively reduced in a short time by continuously repeating the series of operations described above.

As described above, according to the present embodiment, the temperature range of the annealing step for removing the residual strain caused within the glass sheet 19 through the elongation step may be widened in manufacturing the polarizing glass. Therefore, the temperature of the annealing step may be easily controlled, allowing to remove the residual strain within the glass sheet 19 more steadily.

Although the invention has been described by way of the exemplary embodiment, it should be understood that those skilled in the art might make many changes and substitutions without departing from the spirit and scope of the invention. It is obvious from the definition of the appended claims that the embodiment with such modifications also belongs to the scope of the invention.

1. A manufacturing method of polarizing glass, comprising steps of:
precipitating metal halide dispersed within glass into a predetermined particle size to form glass preform after melting said glass containing said metal halide;
elongating said glass preform after heating to predetermined temperature to form a glass sheet containing metal halide particles;
annealing said glass sheet by heating up to temperature below transition temperature and above straining temperature of said glass;
polishing said glass sheet annealed through said annealing step; and
reducing said metal halide particles within said glass sheet polished through said polishing step.

2. The manufacturing method of polarizing glass as set forth in claim 1, wherein the temperature of said glass sheet in said reducing step is lower than the temperature of said glass sheet heated in said annealing step.

3. The manufacturing method of polarizing glass as set forth in claim 1, wherein the temperature of said glass sheet in said reducing step is higher than the melting point of said metal halide.

4. The manufacturing method of polarizing glass as set forth in claim 3, wherein said glass sheet is rocked in said reducing step.

5. The manufacturing method of polarizing glass as set forth in claim 3, wherein said predetermined particle size is 60 nm or less in said precipitating step.

6. The manufacturing method of polarizing glass as set forth in claim 1, wherein said glass preform is heated up to temperature by which viscosity thereof becomes 1×10⁸ poise to 1×10¹⁴ poise and is pulled by tensile force of 100 Kg/cm² to 700 Kg/cm² in said elongation step.

7. The manufacturing method of polarizing glass as set forth in claim 2, wherein the temperature of said glass sheet in said reducing step is higher than the melting point of said metal halide.

8. The manufacturing method of polarizing glass as set forth in claim 7, wherein said glass sheet is rocked in said reducing step.

9. The manufacturing method of polarizing glass as set forth in claim 4, wherein said predetermined particle size is 60 nm or less in said precipitating step.

10. The manufacturing method of polarizing glass as set forth in claim 7, wherein said predetermined particle size is 60 nm or less in said precipitating step.

11. The manufacturing method of polarizing glass as set forth in claim 8, wherein said predetermined particle size is 60 nm or less in said precipitating step.

12. The manufacturing method of polarizing glass as set forth in claim 2, wherein said glass preform is heated up to temperature by which viscosity thereof becomes 1×10⁸ poise to 1×10¹⁴ poise and is pulled by tensile force of 100 Kg/cm² to 700 Kg/cm² in said elongation step.

13. The manufacturing method of polarizing glass as set forth in claim 3, wherein said glass preform is heated up to temperature by which viscosity thereof becomes 1×10⁸ poise to 1×10¹⁴ poise and is pulled by tensile force of 100 Kg/cm² to 700 Kg/cm² in said elongation step.

14. The manufacturing method of polarizing glass as set forth in claim 4, wherein said glass preform is heated up to temperature by which viscosity thereof becomes 1×10⁸ poise to 1×10¹⁴ poise and is pulled by tensile force of 100 Kg/cm² to 700 Kg/cm² in said elongation step.

15. The manufacturing method of polarizing glass as set forth in claim 5, wherein said glass preform is heated up to temperature by which viscosity thereof becomes 1×10⁸ poise to 1×10¹⁴ poise and is pulled by tensile force of 100 Kg/cm² to 700 Kg/cm² in said elongation step.

16. The manufacturing method of polarizing glass as set forth in claim 7, wherein said glass preform is heated up to temperature by which viscosity thereof becomes 1×10⁸ poise to 1×10¹⁴ poise and is pulled by tensile force of 100 Kg/cm² to 700 Kg/cm² in said elongation step.

17. The manufacturing method of polarizing glass as set forth in claim 8, wherein said glass preform is heated up to temperature by which viscosity thereof becomes 1×10⁸ poise to 1×10¹⁴ poise and is pulled by tensile force of 100 Kg/cm² to 700 Kg/cm² in said elongation step.

18. The manufacturing method of polarizing glass as set forth in claim 9, wherein said glass preform is heated up to temperature by which viscosity thereof becomes 1×10⁸ poise to 1×10¹⁴ poise and is pulled by tensile force of 100 Kg/cm² to 700 Kg/cm² in said elongation step.

19. The manufacturing method of polarizing glass as set forth in claim 10, wherein said glass preform is heated up to temperature by which viscosity thereof becomes 1×10⁸ poise to 1×10¹⁴ poise and is pulled by tensile force of 100 Kg/cm² to 700 Kg/cm² in said elongation step.

20. The manufacturing method of polarizing glass as set forth in claim 11, wherein said glass preform is heated up to temperature by which viscosity thereof becomes 1×10⁸ poise to 1×10¹⁴ poise and is pulled by tensile force of 100 Kg/cm² to 700 Kg/cm² in said elongation step.
